(19) United States
(12) Patent Application Publication
(10) Pub. No.: US 2018/0149077 A1
(43) Pub. Date: May 31, 2018

(54) GAS TURBINE SYSTEM WITH PULSATING GAS FLOW FROM AN INTERNAL COMBUSTION ENGINE

(71) Applicant: Galin Stefanov RAYCHINOV, Sofia (BG)

(72) Inventor: Galin Stefanov RAYCHINOV, Sofia (BG)

(21) Appl. No.: 15/572,329

(22) PCT Filed: May 10, 2016
(86) PCT No.: PCT/BG2016/000015

§ 371 Date: Nov. 7, 2017

(30) Foreign Application Priority Data
May 14, 2015 (BG) 112012

(51) Int. Cl. F02B 37/20; F02C 9/18; F02B 37/24; F02B 41/00

(52) U.S. Cl. CPC F02B 37/20; F02B 41/00; F02B 37/24; F02C 9/18

(57) ABSTRACT

A gas turbine system is disclosed having a pulsating gas flow from an internal combustion engine. The system according to the invention provides a reduction in the pressure and velocity of the gas flow in the gas turbine as well as an increase in its total mass which solves the problem for increasing the average weighted efficiency of the gas turbine of the gas turbine system with a pulsating gas stream from an internal combustion engine and the overall system efficiency.

### TECHNICAL FIELD

The present invention relates to a gas turbine system with a pulsating gas flow from an internal combustion engine. Specifically, it provides an increased average weighted efficiency of extracting mechanical energy from the exhaust gases of the internal combustion engine. It is mainly used to utilize the exhaust gases energy of internal combustion engines operating on Otto or Diesel cycles, as well as in other power or energy devices and systems with cyclically repeating operating strokes causing pulsating gas flows or in power units or systems in which pulsating gas flows are intentionally induced.

### BACKGROUND

From many publications and from the practice of motor engineering known are many gas turbine systems with a pulsating gas flow from combustion engines utilizing part of their exhaust gases energy. All such systems include at least a gas turbine whose inlet is connected to an exhaust pipe of an internal combustion engine, the outlet of the turbine being connected to a pipe or system for discharging of the exhaust gases and the shaft of the gas turbine is connected to at least one consumer of mechanical energy. The latter is most often an air compressor that pumps atmospheric air into the suction system of the internal combustion engine and thus ensures its forced filling/induction (so-called turbocharger systems). In other cases, the consumer of the mechanical energy extracted by the gas turbine is another component. For example, in the so-called turbocompound systems, such a component is a transmission with a hydraulic damper of the momentary oscillations, to the internal combustion engine shaft. In some so-called electric hybrid systems, this component is an electric generator. Known are also systems in which there are two consumers of mechanical energy—an electric generator and a charger of the internal combustion engine. In so-called integrated multifunctional systems (for example, according to patent BG 63128 (B1)), such a component is a hydraulic pump. The thus obtained mechanical energy from exhaust gases is used, respectively, for additional mechanical power of the internal combustion engine shaft, for the production of electric energy and simultaneous forced induction of the internal combustion engine, or for the accumulation of energy and subsequent or simultaneous use to drive hydraulic mechanisms, incl. hydraulic motors that add mechanical power to the power of the internal combustion engine. Thus, the overall efficiency of converting the energy of the engine fuel into useful energy for additional engine power or for the operation of a system driven by an engine, such as a vehicle or vehicle system, etc., is increased.

A common drawback of the known gas turbine systems driven by a pulsating gas flow from an internal combustion engine is their relatively low efficiency due to the pulsating nature of the exhaust gases. At each exhaust stroke of any one of the cylinders of the internal combustion engine, a corresponding portion of the exhaust gas passes through the gas turbine in the form of a gas wave with increased but uneven velocity and pressure of the gases along the wave, followed by a wave with reduced but also uneven pressure and velocity. These waves cyclically alternate with the exhaust strokes of the individual cylinders of the engine. Due to this, the gas turbine operates at the maximum efficiency (i.e. at the optimum speed and optimum gas flow pressure) only at very brief moments of passage of waves with increased pressure, and at the rest of the time the efficiency of the turbine is reduced due to the non-optimal velocity and pressure of the gas flow, and there are moments during the passage of waves with a reduced pressure, in which the gas turbine not only does not produce mechanical energy, but even vice versa—uses the inertia of its shaft and of the consumer of mechanical energy to keep its rotation. That is, the instantaneous efficiency of a gas turbine varies between negative and maximum values (usually not exceeding 80-85%) of the alternating exhaust strokes of the individual cylinders of the internal combustion engine. As a result, the average weighted efficiency of known gas turbine systems driven by a pulsating gas flow from an internal combustion engine only rarely reaches about 50% in certain engine operating modes. This is too low in comparison with the efficiency of gas turbines operating with steady (non-pulsating) gas flows reaching up to more than 80% (for the gas turbine itself, not taking into account the energy consumption of the compressor of a gas turbine engine).

### SUMMARY OF THE INVENTION

The object of the invention is to provide an increased efficiency of extracting the mechanical energy of the exhaust gases of the internal combustion engine by means of a gas turbine system.

The solution according to the invention is found by a gas turbine system with a pulsating gas flow from an internal combustion engine comprising a gas turbine whose inlet is connected to an exhaust pipe of an internal combustion engine, the outlet of the gas turbine being connected to a pipe or system for discharging of the exhaust gases, the shaft of the gas turbine is connected to at least one consumer of mechanical energy, characterized in that an ejector is mounted between the exhaust pipe of the internal combustion engine and the inlet of the gas turbine in such a way that the inlet for the driving gas flow of the ejector is connected to the exhaust pipe of the internal combustion engine, the inlet for the driven gas flow of the ejector is connected via a pipe to the outlet of the gas turbine, and the outlet for the aggregate gas flow of the ejector is connected to the inlet of the gas turbine.

In one exemplary embodiment of the gas turbine system with a pulsating gas flow from an internal combustion engine, at least one of the ejector inlets or outlet is adjustable with an regulating device which is connected to a controller that on its part is connected to at least one sensor for any one of the parameters of the operating mode of the internal combustion engine or the consumer of mechanical energy.

In a second embodiment of the gas turbine system with pulsed gas flow from an internal combustion engine, the pipe connecting the outlet of the gas turbine to the inlet for the driven gas flow of the ejector is connected to the gas turbine outlet by means of a non-return valve.

In a third variant embodiment of the gas turbine system with a pulsating gas flow from an internal combustion engine, the pipe connecting the outlet of the gas turbine to the inlet for the driven gas flow of the ejector encompasses the gas turbine and the ejector.

In a fourth embodiment of a gas turbine system with a pulsating gas flow from an internal combustion engine, a gas chamber is installed between the pipe connecting the outlet of the gas turbine to the inlet for the driven gas flow of the ejector.

In a fifth variant embodiment of a gas turbine system with a pulsating gas flow from an internal combustion engine, between the outlet of the gas turbine and the pipe or system for discharging of the exhaust gases is installed a device for temperature and/or energy separation of the exhaust gases flow, whose high-temperature/high-energy outlet is connected to the pipe connected to the inlet for the driven gas flow of the ejector, and its low-temperature/low energy outlet is connected to the pipe or system for discharging of the exhaust gases.

ADVANTAGES of a gas turbine system with a pulsating gas flow from an internal combustion engine according to the invention are numerous.

First of all, the system provides an increased average weighted efficiency of the process of extracting mechanical energy from the exhaust gases of the internal combustion engine. The increased efficiency is a consequence of reduced changes in instantaneous pressure and gas flow velocity in the gas turbine, as well as the effect of the periodic addition of the mass of the driven gas flow in the ejector to the mass of the aggregate gas flow from the ejector. Thus, the efficiency of the gas turbine varies within narrower limits, which, on the one hand, is closer to the maximum efficiency of the turbine, and on the other hand this efficiency refers to the aggregate gas flow from the ejector, which has a greater mass than the driving gas flow. As a result, the average weighted efficiency of the gas turbine is significantly increased in comparison with known gas turbine systems with a pulsating gas flow from an internal combustion engine. This means lower fuel costs for the vehicle (or other system) driven by the engine.

An important advantage of the system is that it provides a reduced thermal load on the system nodes—i.e. both on the impeller and shaft of the gas turbine, as well as on the other nodes that are located close to the gas turbine. It is the result of the “dilution” of the exhaust gases of the engine entering the gas turbine with the relatively cooler exhaust gases that have already passed once through the gas turbine. Thus, the reduced thermal load allows the use of materials which have a lower temperature endurance and are therefore cheaper.

### BRIEF DESCRIPTION OF THE DRAWINGS

FIG. 1 is a block diagram of a system according to the invention according to the first claim.

FIG. 2 is a block diagram of the system according to the invention according to the sixth claim.

### EXAMPLES OF IMPLEMENTATION/PREFERRED EMBODIMENTS

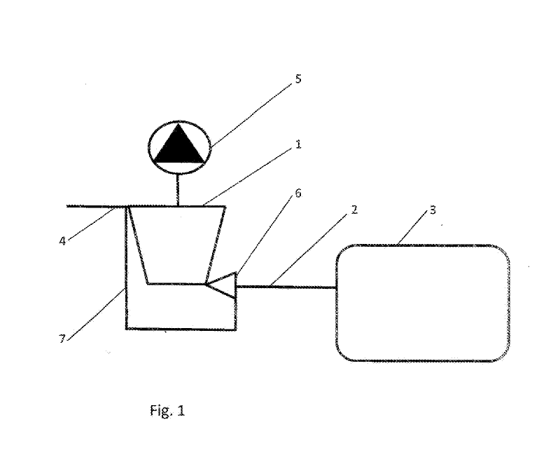

As it can be seen on FIG. 1, the basic embodiment of the system according to the invention comprises a gas turbine 1 whose inlet is connected to an exhaust pipe 2 of an internal combustion engine 3, the outlet of the gas turbine 1 is connected to a pipe or system 4 for discharging of the exhaust gases and the shaft of the gas turbine 1 is connected with at least one consumer of mechanical energy 5. The system is characterized in that an ejector 6 is installed between the exhaust pipe 2 of the internal combustion engine 3 and the inlet of the gas turbine 1 so that the inlet for the driving gas flow of the ejector 6 is connected to the exhaust pipe 2 of the internal combustion engine 3, the inlet for the driven gas flow of the ejector 6 is connected by a pipe 7 to the outlet of the gas turbine 1 (to which the pipe or system 4 for discharging of the exhaust gases is connected in parallel) and the outlet for the aggregate gas flow from the ejector 6 is connected to the inlet of the gas turbine 1.

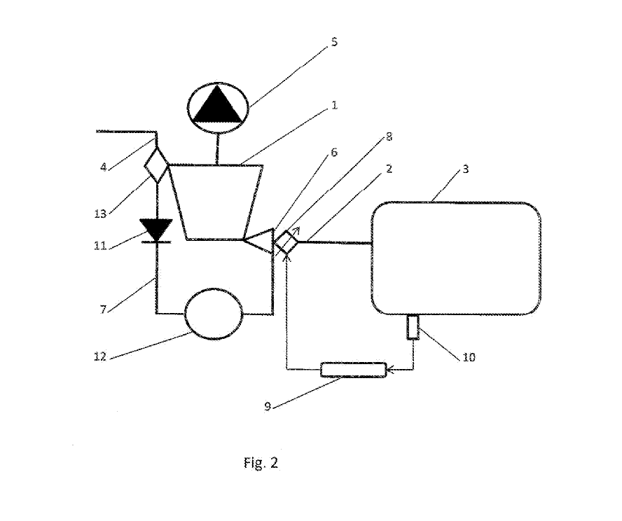

In one variant embodiment of the system according to the invention, at least one of the inlets or outlets of the ejector 6 is adjustable by a regulating device 8 which is connected to a controller 9 which in turn is connected to at least one sensor 10 (as seen in FIG. 2) for any one of the operating parameters of the internal combustion engine 3 or of the consumer of the mechanical energy 5. In this variant embodiment of the system, depending on the application of the internal combustion engine and the need to regulate the ejector 6, additional regulating devices 8 can be installed at the other inlet of the ejector 6 and/or at the outlet for the aggregate gas flow of the ejector 6.

In a second variant embodiment of the system, the pipe 7 is connected to the outlet of the gas turbine 1 by a non-return valve 11 (shown in FIG. 2). It is of the type of the known non-return valves with movable valves, or of the so-called non-return valve of Nikola Tesla, without moving parts.

In a third variant embodiment of the system, the tube 7 encompasses the gas turbine 1 and the ejector 6.

In a fourth variant embodiment, the system is characterized in that a gas chamber 12 is installed between the pipe 7 and the inlet for the driven gas flow of the ejector 6 (as seen in FIG. 2).

In a fifth variant embodiment of the system shown in FIG. 2, it is characterized in that a device 13 for temperature and/or energy separation of the exhaust gases flow is installed between the outlet of the gas turbine 1 and the pipe or system 4 for discharging of the exhaust gases . This is one of the known devices of such action—for example, the Ranque-Hilsch vortex tube. The high-temperature/high-energy outlet of the device 13 is connected to the pipe 7, and the low-temperature/low-energy outlet is connected to the pipe or system 4 for discharging of the exhaust gases.

1. A gas turbine system with a pulsating gas flow from an internal combustion engine comprising:
an exhaust pipe of an internal combustion engine,
an ejector,
a gas turbine,
at least one consumer of mechanical energy,
a tube,
a pipe or system for discharging of the exhaust gases,
the above components being connected as follows:
the exhaust pipe of the internal combustion engine connected to the inlet for the driving gas flow of the ejector,
the inlet of the gas turbine connected to the outlet for the aggregate gas flow from the ejector,
the outlet of the gas turbine connected to the pipe or system for discharging of the exhaust gases,
the outlet of the gas turbine also connected to the inlet of the pipe,
the outlet of the pipe connected to the inlet for the driven gas flow of the ejector,
the shaft of the gas turbine connected to the consumer of mechanical energy,

2. A gas turbine system with a pulsating gas flow from an internal combustion engine according to claim 1, characterized in that at least one of the inlets or outlets of the ejector is adjustable by a regulating device which is connected to a controller which for its part, is connected to at least one sensor for any one of the parameters of the operating mode of the internal combustion engine or of the consumer of mechanical energy.

3. A gas turbine system with a pulsating gas flow from an internal combustion engine according to claim 1, characterized in that the pipe is connected to the outlet of the gas turbine by means of a non-return valve.

4. A gas turbine system with a pulsating gas flow from an internal combustion engine according to claims 3, characterized in that the pipe encompasses the gas turbine and the ejector.

5. A gas turbine system with a pulsating gas flow from an internal combustion engine according to claims 2, characterized in that a gas chamber is installed between the pipe and the inlet for the driven gas flow of the ejector.

6. A gas turbine system with a pulsating gas flow from an internal combustion engine according to claims 1, characterized in that between the outlet of the gas turbine and the pipe or system for discharging of the exhaust gases is installed a device for temperature and/or energy separation of the exhaust gases flow, whose high-temperature/high-energy outlet is connected to the pipe connected to the inlet for the driven gas flow of the ejector, and its low-temperature/low energy outlet is connected to the pipe or system for discharging of the exhaust gases.
